(19) United States
(12) Patent Application Publication
(10) Pub. No.: US 2024/0254044 A1
(43) Pub. Date: Aug. 1, 2024

(54) Method For Calcining Gypsum and Making a Gypsum Board

(71) Applicant: Gold Bond Building Products, LLC, Charlotte, NC (US)

(72) Inventors: R. G. Iyer, Fort Mill, SC (US); Bradley J. Busche, Shelby, NC (US); Joseph J. Bailey, Charlotte, NC (US); Jeff Hawk, Pratt, KS (US); Jesse Fleming, Pratt, KS (US); Matthew McNamar, Medicine Lodge, KS (US)

(21) Appl. No.: 18/409,904

(22) Filed: Jan. 11, 2024

Related U.S. Application Data
(60) Provisional application No. 63/480,532, filed on Jan. 19, 2023.

(51) Int. Cl. C04B 11/00; C04B 11/26; C04B 24/42; C04B 103/30; C04B 111/00

(52) U.S. Cl. CPC C04B 11/005; C04B 11/002; C04B 11/262; C04B 24/42; C04B 2103/304; C04B 2111/0062

(57) ABSTRACT

In general, the present invention is directed to a method of making a gypsum board. The method comprises: applying a phosphorus containing compound to a first gypsum composition to provide a phosphorus modified gypsum composition; calcining the phosphorus modified gypsum composition to provide a calcined gypsum composition; preparing a gypsum slurry by combining water and the calcined gypsum composition; depositing the gypsum slurry on a first facing material; providing a second facing material on the gypsum slurry; and allowing the calcined gypsum to convert to calcium sulfate dihydrate.

### CROSS-REFERENCE TO RELATED APPLICATION

The present application claims filing benefit of U.S. Provisional Patent Application Ser. No. 63/480,532 having a filing date of Jan. 19, 2023, and which is incorporated herein by reference in its entirety.

### BACKGROUND OF THE INVENTION

Gypsum board is commonly employed in drywall construction of interior walls and ceilings and also has other applications. Generally, these gypsum boards are formed from a gypsum slurry including a mixture of calcined gypsum, water, and other conventional additives for various applications. For instance, certain additives may be provided to enhance the moisture-resistance properties of the gypsum board. However, in certain instances, such additives may result in a negative effect on certain characteristics and properties. For instance, such additives may affect the foam resulting in blisters/blows of the gypsum board, cosmetic issues with the gypsum board, and/or other undesired properties. These effects may especially be exhibited when utilizing reclaimed (or recycled) gypsum containing such moisture-resistance additive.

As a result, there is a need to provide an improved method of making a gypsum board.

### SUMMARY OF THE INVENTION

In accordance with one embodiment of the present invention, a method of making a gypsum board is disclosed. The method comprises: applying a phosphorus containing compound to a first gypsum composition to provide a phosphorus modified gypsum composition, wherein the phosphorus containing compound comprises a phosphite, a phosphate having the formula P(O)ₙ(X)ₘ wherein n is from 0 to 4, m is from 0 to 6, the sum of n and m is from 3 to 6, and X is hydrogen, halogen, sulfur, or selenium, a salt thereof, or a mixture thereof; calcining the phosphorus modified gypsum composition to provide a calcined gypsum composition; preparing a gypsum slurry by combining water and the calcined gypsum composition; depositing the gypsum slurry on a first facing material; providing a second facing material on the gypsum slurry; and allowing the calcined gypsum to convert to calcium sulfate dihydrate.

In accordance with another embodiment of the present invention, a gypsum board is disclosed. In particular, the gypsum board is made by the aforementioned method comprising: applying a phosphorus containing compound to a first gypsum composition to provide a phosphorus modified gypsum composition, wherein the phosphorus containing compound comprises a phosphite, a phosphate having the formula P(O)ₙ(X)ₘ wherein n is from 0 to 4, m is from 0 to 6, the sum of n and m is from 3 to 6, and X is hydrogen, halogen, sulfur, or selenium, a salt thereof, or a mixture thereof; calcining the phosphorus modified gypsum composition to provide a calcined gypsum composition; preparing a gypsum slurry by combining water and the calcined gypsum composition; depositing the gypsum slurry on a first facing material; providing a second facing material on the gypsum slurry; and allowing the calcined gypsum to convert to calcium sulfate dihydrate.

In accordance with another embodiment of the present invention, a method of making a gypsum board is disclosed. The method comprises: applying a phosphorus containing compound to a first gypsum composition to provide a phosphorus modified gypsum composition, wherein the first gypsum composition comprises reclaimed gypsum and an organosilicon compound, wherein the phosphorus containing compound comprises a phosphite, a phosphate having the formula P(O)ₙ(X)ₘ wherein n is from 0 to 4, m is from 0 to 6, the sum of n and m is from 3 to 6, and X is hydrogen, halogen, sulfur, or selenium, a salt thereof, or a mixture thereof; calcining the phosphorus modified gypsum composition to provide a calcined gypsum composition; preparing a gypsum slurry by combining water and the calcined gypsum composition; depositing the gypsum slurry on a first facing material; providing a second facing material on the gypsum slurry; and allowing the calcined gypsum to convert to calcium sulfate dihydrate.

In accordance with another embodiment of the present invention, a gypsum board is disclosed. In particular, the gypsum board is made by the aforementioned method comprising: applying a phosphorus containing compound to a first gypsum composition to provide a phosphorus modified gypsum composition, wherein the first gypsum composition comprises reclaimed gypsum and an organosilicon compound, wherein the phosphorus containing compound comprises a phosphite, a phosphate having the formula P(O)ₙ(X)ₘ wherein n is from 0 to 4, m is from 0 to 6, the sum of n and m is from 3 to 6, and X is hydrogen, halogen, sulfur, or selenium, a salt thereof, or a mixture thereof; calcining the phosphorus modified gypsum composition to provide a calcined gypsum composition; preparing a gypsum slurry by combining water and the calcined gypsum composition; depositing the gypsum slurry on a first facing material; providing a second facing material on the gypsum slurry; and allowing the calcined gypsum to convert to calcium sulfate dihydrate.

Other features and aspects of the present invention are set forth in greater detail below.

### DETAILED DESCRIPTION

It is to be understood by one of ordinary skill in the art that the present discussion is a description of exemplary embodiments only and is not intended as limiting the broader aspects of the present invention.

Generally speaking, the present disclosure is directed to a method of making a gypsum board using a certain phosphorus containing compound as defined herein. The present inventors have discovered that the manner in which such compound is provided can result in an improved gypsum board manufacturing process and/or provide a gypsum board with improved properties.

In particular, when providing the phosphorus containing compound as defined herein in the manner as described, the cosmetic properties of the board may be improved. In this regard, the resulting gypsum board may exhibit fewer blisters or blows. In addition, the gypsum core of the resulting gypsum board may have better bond with the facing material, such as a paper facing material. In addition, the method as disclosed herein may also allow for better foam efficiency thereby potentially allowing for less soap usage to obtain a certain weight board.

In general, the method includes at least the following steps: applying a phosphorus containing compound as defined herein to a first gypsum composition to provide a phosphorus modified gypsum composition; calcining the phosphorus modified gypsum composition to provide a calcined gypsum composition; preparing a gypsum slurry by combining water and the calcined gypsum composition; depositing the gypsum slurry on a first facing material;

providing a second facing material on the gypsum slurry; and allowing the calcined gypsum to convert to calcium sulfate dihydrate.

As indicated above, the phosphorus containing compound is applied to a first gypsum composition to provide a phosphorus modified gypsum composition. In general, the phosphorus containing compound may be a phosphite, a phosphate having the formula P(O)ₙ(X)ₘ wherein n is from 0 to 4, m is from 0 to 6, the sum of n and m is from 3 to 6, and X is hydrogen, halogen, sulfur, or selenium, a salt thereof, or a mixture thereof. In one embodiment, the phosphorus containing compound comprises a phosphite or a salt thereof. In another embodiment, the phosphorus containing compound comprises a phosphate having the formula P(O)ₙ(X)ₘ wherein n is from 0 to 4, m is from 0 to 6, the sum of n and m is from 3 to 6, and X is hydrogen, halogen, sulfur, or selenium, or a salt thereof. In a further embodiment, the phosphorus containing compound comprises a combination of a phosphite or a salt thereof and a phosphate having the formula P(O)ₙ(X)ₘ wherein n is from 0 to 4, m is from 0 to 6, the sum of n and m is from 3 to 6, and X is hydrogen, halogen, sulfur, or selenium, or a salt thereof.

As indicated above, the phosphorus containing compound may be a phosphate having the formula P(O)ₙ(X)ₘ wherein n is from 0 to 4, m is from 0 to 6, the sum of n and m is from 3 to 6, and X is hydrogen, halogen, sulfur, or selenium, or a salt thereof. In this regard X may be hydrogen, halogen, or sulfur. For instance, X may be halogen or sulfur. In one embodiment, X may be sulfur. In a further embodiment, X may be selenium. In another embodiment, X may be hydrogen. In another embodiment, X may be halogen. For instance, the halogen may be fluorine (or fluoro), chlorine (or chloro), bromine (or bromo), iodine (or iodo), or any combination thereof. For instance, in one embodiment, the halogen may be fluorine (or fluoro). It should be noted that when m is greater than 1, each X may be independent of another X. That is, each X may be identical or alternatively, one X may be different from another X.

In addition, as indicated above, n is from 0 to 4, such as from 1 to 4, such as from 2 to 4, such as from 2 to 3. Thus, n may be at least 0, such as at least 1, such as at least 2, such as at least 3 to 4 or less, such as 3 or less, such as 2 or less, such as 1 or less. Thus, n may be 0. Further, n may be 1. In another embodiment, n may be 2. In a further embodiment, n may be 3. In another further embodiment, n may be 4.

Also, as indicated above, m is from 0 to 6, such as from 1 to 6, such as from 1 to 5, such as from 1 to 4, such as from 1 to 3, such as from 1 to 2 or 2 to 3. Thus, m may be at least 0, such as at least 1, such as at least 2, such as at least 3, such as at least 4, such as at least 5 to 6 or less, such as 5 or less, such as 4 or less, such as 3 or less, such as 2 or less, such as 1 or less. In this regard, m may be 1. In another embodiment, m may be 2. In a further embodiment, m may be 3. In another further embodiment, m may be 4. In one embodiment, m may be 5. Finally, in a further embodiment, m may be 6.

In addition, as indicated above, the sum of n and m may be from 3 to 6. In this regard, the sum of n and m may be at least 3, such as at least 4, such as at least 5 to 6 or less, such as 5 or less, such as 4 or less. In one embodiment, the sum of n and m may be 3. In another embodiment, the sum of n and m may be 4. In a further embodiment, the sum of n and m may be 5. In another further embodiment, the sum of n and m may be 6.

In one particular embodiment, X may be halogen, such as fluorine (fluoro), n may be 3, and m may be 1. In another particular embodiment, X may be halogen, such as fluorine (fluoro), n may be 2, and m may be 2. In this regard, when X is halogen, the phosphorus containing compound may be referred to as a halophosphate.

When the phosphorus containing compound comprises a halophosphate, the halo may be any halogen atom suitable for the present invention. In this regard, the halogen may be fluorine (or fluoro), chlorine (or chloro), bromine (or bromo), iodine (or iodo), or any combination thereof. For instance, in one embodiment, the halogen may be fluorine (or fluoro) such that the halophosphate is a fluorophosphate. In another embodiment, the halogen may be chlorine (or chloro) such that the halophosphate is a chlorophosphate.

Further, the halophosphate may comprise any number of halogen atoms. For instance, the halophosphate may include at least 1 halogen atom, such as at least 2 halogen atoms, such as at least 3 halogen atoms, such as at least 4 halogen atoms, such as at least 5 halogen atoms, such as at least 6 halogen atoms. In this regard, the halophosphate may be a monohalophosphate, a dihalophosphate, a trihalophosphate, a tetrahalophosphate, a pentahalophosphate, a hexahalophosphate, or any mixture thereof. In one embodiment, the halophosphate includes a monohalophosphate. In another embodiment, the halophosphate includes a dihalophosphate.

As indicated above, the halogen may be fluorine. In this regard, the halophosphate may be a fluorophosphate. In particular, the fluorophosphate may be a monofluorophosphate, a difluorophosphate, a trifluorophosphate, a tetrafluorophosphate, a pentafluorophosphate, a hexafluorophosphate, or any mixture thereof. In one embodiment, the fluorophosphate may include a monofluorophosphate. In another embodiment, the fluorophosphate may include a difluorophosphate.

As also indicated above, X may be a hydrogen. In this regard, m may be 1. In one embodiment, m may be 2 such that the phosphate is a dihydrogen phosphate. In a particular embodiment, the compound may be a bis(dihydrogen phosphate). In another particular embodiment, the compound may be a tris(dihydrogen phosphate).

As indicated above, the phosphorus containing compound may be a phosphite. For instance, the phosphite may be an anion having the general formula [HPO₃]²⁻. In this regard, the phosphite may be a salt of phosphorus acid. In one embodiment, the phosphite may have the formula of the aforementioned phosphate wherein X is H. The remaining parameters of such formula may be the same as defined above and herein with respect to the phosphate. For instance, in the above formula, n may be 3 and m may be 1.

Furthermore, the phosphorus containing compound may be a salt. In this regard, the phosphorus containing compound may include ammonium, a metal, or a combination thereof. In one embodiment, the phosphorus containing compound includes ammonium. In another embodiment, the phosphorus containing compound includes a metal.

When the phosphorus containing compound includes a metal, the metal may be any employed in the art. For instance, the metal may be an alkali metal, an alkaline earth metal, a transition metal, or a combination thereof. In one embodiment, the metal may be an alkali metal. For instance, the alkali metal may be lithium, sodium, potassium, or a combination thereof. In one particular embodiment, the alkali metal may be sodium, potassium, or a combination thereof. In another particular embodiment, the alkali metal may include sodium.

In another embodiment, the metal may be an alkaline earth metal. For instance, the alkaline earth metal may be beryllium, magnesium, calcium, strontium, barium, or a combination thereof. In one particular embodiment, the alkaline earth metal may be magnesium, calcium, or a combination thereof.

In a further embodiment, the metal may be a transition metal. For instance, the transition metal may be manganese, iron, cobalt, nickel, copper, zinc, titanium, chromium, platinum, gold, molybdenum, palladium, silver, tantalum, tungsten, etc., or a combination thereof.

In addition to alkali metals, alkaline earth metals, and transition metals, other metals may also be employed. For instance, the metal may be aluminum, indium, tin, bismuth, etc., or a combination thereof.

Furthermore, one mole of metal may be present. Alternatively, in one embodiment, two moles of metal may be present. As an example, the metal may simply be sodium. Alternatively, the metal may be disodium. In this regard, the number of moles of metal may depend on the charge of the anion.

Without intending to be limited, the benefits may be realized due to interactions with the phosphorus containing compound. For example, the halophosphate may bond to certain atoms, such as silicon atoms, due to favorable bonds. For instance, when containing an organosilicon compound as described herein, this may result in the formation of energetically favorable Si—F bonds and thus reduce the water-repellant effects of the alkyl (R) groups of the organosilicon compound. With the precalcination addition of the phosphorus containing compound as disclosed herein, it may contribute to an increased breakage of Si—R bonds and reduce or eliminate the negative effects of silicone waste on foam formation.

The method of application of the phosphorus containing compound may be any as generally known in the art. For instance, the method may include misting, spraying, mixing/blending, grinding, etc. Accordingly, the manner in which the phosphorus containing compound is applied is not necessarily limited by the present disclosure. In addition, the phosphorus containing compound may be applied as a solid, as a dispersion/solution, or a combination thereof. Furthermore, once applied, the modified gypsum composition may be utilized immediately for calcining (or combining with a virgin gypsum to provide a second gypsum composition as disclosed herein). Alternatively, it may be stored for a certain period of time. For instance, it may be allowed to dry to remove free moisture or free water prior to calcining.

In one embodiment, a polyol compound may also be provided or applied to a first gypsum composition as defined herein. In this regard, the method may include a step of applying a phosphorus containing compound as defined herein and a polyol compound to a first gypsum composition to provide a phosphorus modified gypsum composition. Such phosphorus modified gypsum composition may also contain the polyol compound.

Furthermore, the application of the polyol compound may be the same or different as the phosphorus containing compound. In this regard, the method of application of the polyol compound may be any as generally known in the art. For instance, the method may include misting, spraying, mixing/blending, grinding, etc. Accordingly, the manner in which the polyol compound is applied is not necessarily limited by the present disclosure. In addition, the polyol compound may be applied as a solid, as a dispersion/solution, or a combination thereof.

In one embodiment, the polyol compound may be provided or applied with the phosphorus containing compound. For instance, they may be provided as a mixture in one embodiment wherein the polyol compound and the phosphorus containing compound are combined or mixed. In another embodiment, they may be provided separately. For instance, they may not be mixed but may be provided or applied separately to the first gypsum composition. While being provided separately, they may be provided simultaneously in one embodiment. In another embodiment, they may be provided consecutively.

In general, the polyol compound may be any polyol compound. For instance, the polyol compound may be a sugar, a sugar alcohol, a polyether, a polysaccharide, or a mixture thereof. In one embodiment, the polyol compound may include glycerol. In another embodiment, the polyol compound may include a sugar. In a further embodiment, the polyol compound may include a sugar alcohol. In an even further embodiment, the polyol compound may include a polyether. In another further embodiment, the polyol compound may include a polysaccharide.

As indicated above, the polyol compound may include a sugar. The sugar may be glucose, sucrose, fructose, lactose, dextrose, or a mixture thereof. In one embodiment, the sugar may be glucose. In another embodiment, the sugar may be sucrose. In a further embodiment, the sugar may be fructose. In an even further embodiment, the sugar may be lactose. In a further embodiment, the sugar may be dextrose.

As indicated above, the polyol compound may include a sugar alcohol. The sugar alcohol may be glycerol, maltitol, sorbitol, mannitol, xylitol, erythritol, isomalt, threitol, arabitol, galactitol, fucitol, iditol, inositol, volemitol, lactitol, or a mixture thereof. In one embodiment, the sugar alcohol may be glycerol. In another embodiment, the sugar alcohol may be sorbitol. In a further embodiment, the sugar alcohol may be mannitol. In an even further embodiment, the sugar alcohol may be erythritol. In another embodiment, the sugar alcohol may be xylitol.

The sugar alcohol may have from 3 carbon atoms to 24 carbon atoms. For instance, the sugar alcohol may have 3 or more carbon atoms, such as 4 or more carbon atoms, such as 5 or more carbon atoms, such as 6 or more carbon atoms, such as 7 or more carbon atoms, such as 8 or more carbon atoms, such as 10 or more carbon atoms, such as 12 or more carbon atoms, such as 16 or more carbon atoms, such as 20 or more carbon atoms. The sugar alcohol may have 24 or less carbon atoms, such as 20 or less carbon atoms, such as 18 or less carbon atoms, such as 14 or less carbon atoms, such as 10 or less carbon atoms, such as 8 or less carbon atoms, such as 6 or less carbon atoms, such as 5 or less carbon atoms, such as 4 or less carbon atoms. For instance, the sugar alcohol may have 3 carbon atoms. In another embodiment, the sugar alcohol may have 4 carbon atoms. In a further embodiment, the sugar alcohol may have 5 carbon atoms. In an even further embodiment, the sugar alcohol may have 6 carbon atoms.

As indicated above, the polyol compound may include a polyether. The polyether may include polyethylene glycol, polypropylene glycol, polyglycerol, a polyglycerol ester, or a mixture thereof. In one embodiment, the polyether may include polyethylene glycol. In another embodiment, the polyether may include polypropylene glycol. In a further embodiment, the polyether may be a polyglycerol. In another embodiment, the polyether may be a polyglycerol ester. For example, the polyglycerol ester may be a fatty acid ester.

As indicated above, the polyol compound may include a polysaccharide. In general, a polysaccharide includes a large number of glucose monosaccharide units joined together by glycosidic bonds. Generally, polysaccharides can be found in plants and seeds. The polysaccharide may be chitin, chitosan, alginate, polydextrose, cyclodextrin, or a mixture thereof. In this regard, in one embodiment, the polysaccharide may be a dextrin. For instance, the dextrin may be a maltodextrin. The polysaccharide may be a starch. For instance, the starch may be a corn starch, a wheat starch, a milo starch, a potato starch, a rice starch, an oat starch, a barley starch, a cassava starch, a tapioca starch, a pea starch, a rye starch, an amaranth starch, or other commercially available starch.

In one embodiment, the polyol compound may be a modified polyol compound. For instance, the modified polyol compound may be an ethoxylated polyol compound, an esterified polyol compound, or a mixture thereof. In one embodiment, the modified polyol compound may be an ethoxylated polyol compound. In another embodiment, the modified polyol compound may be an esterified polyol compound.

Also, it should be understood that the polyol compound may include a combination of polyol compounds, such as any of those mentioned above. For instance, it should be understood that the polyol compound may include more than one different polyol compound. For instance, in one embodiment, at least two different polyol compounds may be utilized. In another embodiment, at least three different polyol compounds may be utilized.

The polyol compound may have a relatively low molecular weight. For instance, the molecular weight may be 5,000 g/mol or less, such as 4,000 g/mol or less, such as 3,000 g/mol or less, such as 2,000 g/mol or less, such as 1,800 g/mol or less, such as 1,600 g/mol or less, such as 1,400 g/mol or less, such as 1,200 g/mol or less, such as 1,000 g/mol or less, such as 800 g/mol or less, such as 600 g/mol or less, such as 500 g/mol or less, such as 400 g/mol or less, such as 300 g/mol or less, such as 200 g/mol or less. The molecular weight may be 25 g/mol or more, such as 50 g/mol or more, such as 75 g/mol or more, such as 100 g/mol or more, such as 125 g/mol or more, such as 150 g/mol or more, such as 200 g/mol or more, such as 250 g/mol or more, such as 300 g/mol or more, such as 400 g/mol or more, such as 500 g/mol or more.

The polyol compound may be present in an amount of 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.5 wt. % or more based on the weight of the gypsum board. The polyol compound may be present in an amount of 10 wt. % or less, such as 7 wt. % or less, such as 5 wt. % or less, such as 4 wt. % or less, such as 3 wt. % or less, such as 2.5 wt. % or less, such as 2 wt. % or less, such as 1.8 wt. % or less, such as 1.5 wt. % or less, such as 1 wt. % or less, such as 0.8 wt. % or less, such as 0.6 wt. % or less, such as 0.5 wt. % or less, such as 0.4 wt. % or less, such as 0.35 wt. % or less, such as 0.2 wt. % or less based on the weight of the gypsum board. Alternatively, the weight percentage may be based on the weight of the gypsum core. In a further embodiment, such weight percentage may be based on the weight of the gypsum within the gypsum core. In an even further embodiment, such weight percentage may be based on the weight of a respective gypsum core section. Also, the aforementioned weight percentages may be based on the solids content of the gypsum slurry.

The polyol compound may be provided in a certain amount relative to the phosphorus containing compound. For instance, the weight ratio of the polyol compound to the phosphorus containing compound may be more than 0, such as 0.001 or more, such as 0.01 or more, such as 0.05 or more, such as 0.1 or more, such as 0.2 or more, such as 0.3 or more, such as 0.5 or more, such as 1 or more, such as 2 or more, such as 3 or more, such as 4 or more, such as 5 or more, such as 8 or more, such as 10 or more, such as 15 or more, such as 20 or more, such as 25 or more, such as 30 or more, such as 40 or more, such as 50 or more, such as 60 or more, such as 70 or more, such as 80 or more, such as 90 or more. The weight ratio may be less than 100, such as 99.9 or less, such as 99.8 or less, such as 99.5 or less, such as 99 or less, such as 98 or less, such as 97 or less, such as 95 or less, such as 90 or less, such as 80 or less, such as 70 or less, such as 60 or less, such as 50 or less, such as 40 or less, such as 30 or less, such as 25 or less, such as 20 or less, such as 15 or less, such as 10 or less, such as 9 or less, such as 8 or less, such as 7 or less, such as 6 or less, such as 5 or less, such as 4 or less, such as 3.5 or less, such as 3 or less, such as 2.5 or less, such as 2 or less, such as 1.5 or less, such as 1 or less, such as 0.8 or less, such as 0.5 or less.

In general, the first gypsum composition comprises gypsum. For instance, the gypsum may be uncalcined. In this regard, the gypsum may comprise calcium sulfate dihydrate. The gypsum may be a virgin gypsum, a reclaimed gypsum, or a mixture thereof. In one embodiment, the gypsum may be reclaimed gypsum. In another embodiment, the gypsum may be virgin gypsum. In a further embodiment, the gypsum may be a mixture of a virgin gypsum and a reclaimed gypsum. The source of the gypsum, whether for the virgin gypsum or the reclaimed gypsum, may be a natural source or a synthetic source and is thus not necessarily limited by the present invention.

As generally understood, virgin gypsum is gypsum that has not been processed to make a product or article whereas reclaimed gypsum is gypsum that has been made into a product or article and is being reclaimed or recycled. In this regard, such gypsum directly from a natural source or a synthetic source may be referred to as a virgin gypsum. Meanwhile, reclaimed gypsum may be virgin gypsum that has been used and processed (e.g., for making a gypsum board) and is being recycled in the gypsum board manufacturing process to make a new gypsum board.

Thus, the gypsum to which the phosphorus containing compound, and if present the polyol compound, is being applied may be virgin gypsum, reclaimed gypsum, or a combination thereof. In one embodiment, the gypsum may be virgin gypsum. In another embodiment, the gypsum may be reclaimed gypsum. In a further embodiment, the gypsum may be a mixture of virgin gypsum and reclaimed gypsum. When present as a mixture, the amount of reclaimed gypsum is not necessarily limited.

In general, when the first gypsum composition comprises reclaimed gypsum, certain benefits may be realized. For instance, such use of reclaimed gypsum may allow for a reduction in the amount of waste. In this regard, rather than sending used gypsum product/boards to waste or a landfill, such gypsum may be reclaimed or recycled. In this regard, the method as disclosed herein may also be environmentally friendly.

In this regard, when the first gypsum composition comprises reclaimed gypsum, it may also include other components. For instance, the first gypsum composition may also comprise a reclaimed facing material. For instance, the facing material may be as one described herein. In particular, the reclaimed facing material may be a reclaimed paper facing material. The first gypsum composition may also comprise an organosilicon compound, in particular a reclaimed organosilicon compound. For instance, such organosilicon compound may have been utilized in forming the gypsum product or article that is being reclaimed. In a particular embodiment, the first gypsum composition may comprise a mixture of the reclaimed facing material and the organosilicon compound along with the gypsum as defined herein.

The organosilicon compound may comprise a silane, a polymethylhydrogensiloxane, a siloxane resin, a polysilane, an organosilanol, a disiloxane, an oligosiloxane, a polysiloxane, an organosiliconate, or a mixture thereof. Suitable organosilicon compounds encompass, for example, silanes such as tetraorganosilanes SiR₄ and organoorganoxysilanes SiRₙ (OR′)₄₋ₙ with n=1 to 3, polymethylhydrogensiloxanes, siloxane resins, polysilanes preferably of the general formula R₃Si (SiR₂)ₙSiR₃ with n=0 to 500, organosilanols such as SiRₙ (OH)₄₋ₙ, disiloxanes, oligosiloxanes, polysiloxanes for example composed of units of the general formula R_{c}H_{d}Si (OR′)ₑ(OH)_{f}O_{(4-c-d-e-f)}/2 with c=0 to 3, d=0 to 1, e=0 to 3, f=0 to 3, and with the sum c+d+e+f per unit being no more than 3.5, with R in each case being identical or different and denoting branched or unbranched alkyl radicals having 1 to 22 C atoms, cycloalkyl radicals having 3 to 10 C atoms, alkylene radicals having 2 to 4 C atoms, and also aryl, aralkyl, and alkylaryl radicals having 6 to 18 C atoms, and R′ denoting identical or different alkyl radicals and alkoxyalkylene radicals having in each case 1 to 4 C atoms, preferably methyl and ethyl, it also being possible for the radicals R and R′ to be substituted by halogens such as chlorine, by ether, thioether, ester, amide, nitrile, hydroxyl, amine, carboxyl, sulfonic acid, carboxylic anhydride, and carbonyl groups, and in the case of the polysilanes it also being possible for R to have the definition OR′.

Further examples of the organosilicon compounds are organosiliconates, more particularly alkyl siliconates, such as monomeric or oligomeric alkylsilanetriols. Organosiliconates are obtainable, for example, by reaction of one or more organoalkoxysilanes with one or more polyhydroxy compounds or, preferably, with one or more alkali metal lyes. Organoalkoxysilanes preferred for the preparation of organosiliconates are methyltrimethoxysilane, methyltriethoxysilane, ethyltrialkoxysilane, propyltri-methoxysilanes, butyltrimethoxysilanes, pentyltri-alkoxysilanes, hexyltrimethoxysilanes, heptyltrimethoxysilanes, octyltrimethoxysilanes. Examples of alkali metal lyes are sodium hydroxide or potassium hydroxide, more particularly in the form of their aqueous solutions. Examples of suitable polyhydroxy compounds are alkanediols, such as ethylene glycol, diethylene glycol, triethylene glycol, polyethylene glycol, 1,2-propanediol or 1,3-propanediol, alkanetriols, such as glycerol, alkanetetrols, such as pentaerythritol, hydroxycarboxylic acids, such as lactic acid, citric acid, or tartaric acid, saccharides, such as sugars, more particularly glucose, sucrose, or fructose, or starch. The reaction products may comprise basic or acidic constituents, examples being catalysts which may be added in order to promote the elimination of alkoxy groups.

Particularly preferred organosilicon compounds are methyl-trimethoxysilane, methyltriethoxysilane, ethyltrimethoxysilane, ethyltriethoxysilane, propyltrimethoxysilanes, propyltriethoxysilanes, n-butyltrimethoxysilane, isobutyltrimethoxysilane, pentyltrimethoxysilanes, hexyltrimethoxysilanes, cyclohexyltrimethoxysilane, methyltripropoxysilane, methyltri-(ethoxyethoxy)silane, vinyltri(methoxyethoxy)silane, (meth)acryloyloxypropyltrimethoxysilane, (meth)acryloyloxypro-pyltriethoxysilane, γ-chloropropyltriethoxysilane, β-nitrilo-ethyltriethoxysilane, γ-mercaPtopropyltrimethoxysilane, γ-mer-captopropyltriethoxysilane, phenyltriethoxysilane, heptyltrimethoxysilane, heptyltriethoxysilanes, isooctyltri-ethoxysilane, n-octyltriethoxysilane, hexadecyltriethoxysilanes, dipropyldiethoxysilanes, methylphenyldiethoxysilane, diphenyldimethoxysilane, methylvinyltri(ethoxyethoxy)silane, tetramethyldiethoxy-disilane, trimethyltrimethoxydisilane, trimethyltriethoxydisilane, dimethyltetramethoxydisilane, dimethyltetraethoxydisilane, methylhydrogenpolysiloxanes endblocked with trimethylsiloxy groups, copolymers endblocked with trimethylsiloxy groups and composed of dimethylsiloxane and methylhydrogensiloxane units, dimethylpolysiloxanes, and also dimethylpolysiloxanes with Si—OH groups in the terminal units.

In addition to the above, the first gypsum composition may include other components. For instance, these other components may include those present with the reclaimed gypsum in the gypsum product/article. In this regard, these other components may include those conventionally utilized in the art. In particular, these may include those conventional additives as indicated below. Furthermore, they may be included in the first gypsum composition in the amount as disclosed below with respect to conventional additives and/or in the amount as disclosed below with respect to the organosilicon compound.

Furthermore, in the first gypsum composition, the reclaimed gypsum may be present in an amount of 1 wt. % or more, such as 2 wt. % or more, such as 3 wt. % or more, such as 5 wt. % or more, such as 10 wt. % or more, such as 15 wt. % or more, such as 20 wt. % or more, such as 25 wt. % or more, such as 30 wt. % or more, such as 35 wt. % or more, such as 40 wt. % or more, such as 45 wt. % or more, such as 50 wt. % or more, such as 60 wt. % or more, such as 70 wt. % or more, such as 80 wt. % or more, such as 90 wt. % or more, such as 95 wt. % or more based on the total weight of the gypsum in the composition. The reclaimed gypsum may be present in an amount of 100 wt. % or less, such as 90 wt. % or less, such as 80 wt. % or less, such as 70 wt. % or less, such as 60 wt. % or less, such as 50 wt. % or less, such as 40 wt. % or less, such as 35 wt. % or less, such as 30 wt. % or less, such as 25 wt. % or less, such as 20 wt. % or less, such as 15 wt. % or less, such as 10 wt. % or less based on the total weight of the gypsum in the composition. In one embodiment, such aforementioned weight percentages may also refer to the weight percentages of the reclaimed gypsum based on the weight of the first gypsum composition. In another embodiment, such aforementioned weight percentages may also refer to the weight percentages based on gypsum, in particular calcined gypsum, in the gypsum slurry as defined herein. In one embodiment, such aforementioned weight percentages may also refer to the weight percentages based on gypsum in the gypsum board as defined herein.

In addition, in the first gypsum composition, the organosilicon compound may be present in an amount of 0.0001 wt. % or more, such as 0.001 wt. % or more, such as 0.005 wt. % or more, such as 0.01 wt. % or more, such as 0.05 wt. % or more, such as 0.1 wt. % or more, such as 0.2 wt. % or more, such as 0.3 wt. % or more, such as 0.5 wt. % or more, such as 1 wt. % or more, such as 2 wt. % or more based on the weight of the first gypsum composition. The organosilicon compound may be present in an amount of 10 wt. % or less, such as 8 wt. % or less, such as 6 wt. % or less, such as 5 wt. % or less, such as 4 wt. % or less, such as 3 wt. % or less, such as 2.5 wt. % or less, such as 2 wt. % or less, such as 1.5 wt. % or less, such as 1.3 wt. % or less, such as 1 wt. % or less, such as 0.8 wt. % or less, such as 0.5 wt. % or less, such as 0.3 wt. % or less based on the weight of the first gypsum composition. In one embodiment, such aforementioned weight percentages may also refer to the weight percentages of the organosilicon compound based on the weight of gypsum in the first gypsum composition. In another embodiment, such aforementioned weight percentages may also refer to the weight percentages based on reclaimed gypsum in the first gypsum composition.

In one embodiment, the gypsum board may be made from a combination of virgin gypsum and reclaimed gypsum. In this regard, in one embodiment, the application of the phosphorus containing compound, and if present the polyol compound, may be to a first gypsum composition comprising virgin gypsum and reclaimed gypsum to provide a phosphorus modified gypsum composition. Such phosphorus modified gypsum composition may also contain the polyol compound if applied to the first gypsum composition. In another embodiment, the application of the phosphorus containing compound, and if present the polyol compound, may be to a first gypsum composition comprising reclaimed gypsum to provide a phosphorus modified gypsum composition. Such phosphorus modified gypsum composition may also contain the polyol compound if applied to the first gypsum composition. Thereafter in such embodiment, the phosphorus modified gypsum composition may be combined with virgin gypsum to provide a second gypsum composition. Such second gypsum composition may also contain the polyol compound if applied to the first gypsum composition. Then, the second gypsum composition may be calcined to provide a calcined gypsum composition. Such calcined gypsum composition may also contain the polyol compound if applied to the first gypsum composition.

In this regard, in the second gypsum composition, the reclaimed gypsum may be present in an amount of 1 wt. % or more, such as 2 wt. % or more, such as 3 wt. % or more, such as 5 wt. % or more, such as 10 wt. % or more, such as 15 wt. % or more, such as 20 wt. % or more, such as 25 wt. % or more, such as 30 wt. % or more, such as 35 wt. % or more, such as 40 wt. % or more, such as 45 wt. % or more, such as 50 wt. % or more, such as 60 wt. % or more, such as 70 wt. % or more, such as 80 wt. % or more, such as 90 wt. % or more, such as 95 wt. % or more based on the total weight of the gypsum in the composition. The reclaimed gypsum may be present in an amount of 100 wt. % or less, such as 90 wt. % or less, such as 80 wt. % or less, such as 70 wt. % or less, such as 60 wt. % or less, such as 50 wt. % or less, such as 40 wt. % or less, such as 35 wt. % or less, such as 30 wt. % or less, such as 25 wt. % or less, such as 20 wt. % or less, such as 15 wt. % or less, such as 10 wt. % or less based on the total weight of the gypsum in the composition. In one embodiment, such aforementioned weight percentages may also refer to the weight percentages of the reclaimed gypsum based on the weight of the second gypsum composition. In another embodiment, such aforementioned weight percentages may also refer to the weight percentages based on gypsum, in particular calcined gypsum, in the gypsum slurry as defined herein. In one embodiment, such aforementioned weight percentages may also refer to the weight percentages based on gypsum in the gypsum board as defined herein.

Generally, calcined gypsum may be referred to as calcium sulfate hemihydrate. The manner in which calcination may occur is not limited by the present disclosure and can be conducted using any means generally known in the art. The calcination (or dehydration) process in the manufacture of stucco (i.e., calcium sulfate hemihydrate) is performed by heating the gypsum which yields calcium sulfate hemihydrate and water vapor. In particular, the calcination removes bound water from the gypsum (i.e., calcium sulfate dihydrate) to yield stucco (i.e., calcium sulfate hemihydrate). Generally, this may be conducted using any “calciner” known in the art and is not limited by the present invention. For instance, any suitable furnace or reactor may be used. As examples, a kettle calciner, a flash calciner, a rotary kiln, or a combination thereof may be used to carry out the calcination. As one example, a flash calcination process is disclosed in U.S. Ser. No. 11/446,620, which is incorporated herein by reference in its entirety. What is important is that the calcination is done at substantially atmospheric pressure and is usually done in a continuous (as contrasted with a batch) process so that the requisite form of the hemihydrate, beta-gypsum and/or alpha-gypsum, would be produced.

The calcination may also be conducted using a single staged apparatus or a multi-staged apparatus. Furthermore, in one embodiment, the calcination may be conducted in a continuous process. In another embodiment, the calcination may be conducted in a batch process.

The calcination may be conducted at any temperature suitable to convert gypsum to stucco. For instance, calcining may be carried out at a temperature of about 100° C. or more, such as about 120° C. or more, such as about 140° C. or more, such as about 160° C. or more, such as about 180° ° C. or more, such as about 200° C. or more, such as about 220° C. or more, such as about 240° C. or more, such as about 300° C. or more, such as about 400° C. or more, such as about 500° C. or more, such as about 600° C. or more, such as about 800° C. or more, such as about 1,000° C. or more. The calcining may be carried out at a temperature of about 1,300° C. or less, such as about 1,100° C. or less, such as about 1,000° C. or less, such as about 800° C. or less, such as about 700° C. or less, such as about 600° C. or less, such as about 500° C. or less, such as about 400° C. or less, such as about 300° C. or less, such as about 280° C. or less, such as about 260° C. or less, such as about 240° C. or less, such as about 220° C. or less, such as about 200° C. or less, such as about 180° C. or less, such as about 160° C. or less, such as about 140° C. or less.

The calcining may be conducted for any suitable period of time as required to reduce the content of the bound water from the gypsum to on-average one-half of mole of water per mole of calcium sulfate (i.e., to calcium sulfate hemihydrate). However, generally, the calcination may not be conducted for such period of time to promote formation, in particular considerable formation, of insoluble anhydrous gypsum. In this regard, the calcining may be conducted such that the average residence time of the gypsum in the calciner is about 0.001 hours or more, such as 0.005 hours or more, such as 0.01 hours or more, such as 0.05 hours or more, such as 0.1 hours or more, such as 0.2 hours or more, such as 0.5 hours or more, such as 0.75 hours or more, such as 1 hour or more, such as 1.5 hours or more, such as 2 hours or more. The average residence time may be 5 hours or less, such as 4 hours or less, such as 3 hours or less, such as 2.5 hours or less, such as 2 hours or less, such as 1.8 hours or less, such as 1.6 hours or less, such as 1.4 hours or less, such as 1.2 hours or less, such as 1 hour or less, such as 0.8 hours or less, such as 0.6 hours or less, such as 0.5 hours or less, such as 0.4 hours or less, such as 0.3 hours or less, such as 0.2 hours or less, such as 0.1 hours or less, such as 0.05 hours or less, such as 0.01 hours or less.

Furthermore, even though the phosphorus modified gypsum composition or second gypsum composition have been calcined to form a calcined gypsum composition, in some embodiments, the calcined gypsum composition may contain the phosphorus containing compound. In this regard, the phosphorus containing compound may be present in an amount of 10 wt. % or less, such as 8 wt. % or less, such as 6 wt. % or less, such as 5 wt. % or less, such as 4 wt. % or less, such as 3 wt. % or less, such as 2 wt. % or less, such as 1.5 wt. % or less, such as 1 wt. % or less, such as 0.8 wt. % or less, such as 0.6 wt. % or less, such as 0.5 wt. % or less, such as 0.4 wt. % or less, such as 0.3 wt. % or less, such as 0.2 wt. % or less, such as 0.1 wt. % or less based on the weight of the calcined gypsum composition. The phosphorus containing compound may be present in an amount of 0.0001 wt. % or more, such as 0.001 wt. % or more, such as 0.005 wt. % or more, such as 0.01 wt. % or more, such as 0.02 wt. % or more, such as 0.05 wt. % or more, such as 0.1 wt. % or more, such as 0.2 wt. % or more, such as 0.3 wt. % or more, such as 0.5 wt. % or more, such as 1 wt. % or more based on the weight of the calcined gypsum composition.

Further, if a polyol compound is utilized, the polyol compound may be present in an amount of 10 wt. % or less, such as 8 wt. % or less, such as 6 wt. % or less, such as 5 wt. % or less, such as 4 wt. % or less, such as 3 wt. % or less, such as 2 wt. % or less, such as 1.5 wt. % or less, such as 1 wt. % or less, such as 0.8 wt. % or less, such as 0.6 wt. % or less, such as 0.5 wt. % or less, such as 0.4 wt. % or less, such as 0.3 wt. % or less, such as 0.2 wt. % or less, such as 0.1 wt. % or less based on the weight of the calcined gypsum composition. The polyol compound may be present in an amount of 0.0001 wt. % or more, such as 0.001 wt. % or more, such as 0.005 wt. % or more, such as 0.01 wt. % or more, such as 0.02 wt. % or more, such as 0.05 wt. % or more, such as 0.1 wt. % or more, such as 0.2 wt. % or more, such as 0.3 wt. % or more, such as 0.5 wt. % or more, such as 1 wt. % or more based on the weight of the calcined gypsum composition.

After calcination, a gypsum slurry is prepared. The gypsum slurry can be prepared by combining water and the calcined gypsum composition. In addition, optional additives may also be combined to form the gypsum slurry.

For instance, in addition to the calcined gypsum composition which comprises calcined gypsum (i.e., stucco or calcium sulfate hemihydrate), the gypsum slurry may also be formed by providing calcium sulfate dihydrate and/or calcium sulfate anhydrite. If calcium sulfate dihydrate is present, the hemihydrate is present in an amount of at least 50 wt. %, such as at least 60 wt. %, such as at least 70 wt. %, such as at least 80 wt. %, such as at least 85 wt. %, such as at least 90 wt. %, such as at least 95 wt. %, such as at least 98 wt. %, such as at least 99 wt. %, based on the weight of the calcium sulfate hemihydrate and the calcium sulfate dihydrate. Furthermore, the calcined gypsum may be α-hemihydrate, β-hemihydrate, or a mixture thereof.

In addition to the calcined gypsum composition, the gypsum slurry may also contain other hydraulic materials. These hydraulic materials may include land plaster, cement, fly ash, or any combinations thereof. When present, they may be utilized in an amount of 30 wt. % or less, such as 25 wt. % or less, such as 20 wt. % or less, such as 15 wt. % or less, such as 10 wt. % or less, such as 8 wt. % or less, such as 5 wt. % or less based on the total content of the hydraulic material.

The phosphorus containing compound may be present in the gypsum slurry in an amount of 0.001 wt. % or more, such as 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.5 wt. % or more based on the weight of the calcined gypsum composition. The phosphorus containing compound may be present in an amount of 10 wt. % or less, such as 7 wt. % or less, such as 5 wt. % or less, such as 4 wt. % or less, such as 3 wt. % or less, such as 2.5 wt. % or less, such as 2 wt. % or less, such as 1.8 wt. % or less, such as 1.5 wt. % or less, such as 1 wt. % or less, such as 0.8 wt. % or less, such as 0.6 wt. % or less, such as 0.5 wt. % or less, such as 0.4 wt. % or less, such as 0.35 wt. % or less, such as 0.2 wt. % or less based on the weight of the calcined gypsum composition. In one embodiment, the aforementioned weight percentages may be based on the weight of the calcined gypsum present in the calcined gypsum composition.

The phosphorus containing compound may be present in an amount of 0.001 lbs/MSF or more, such as 0.01 lbs/MSF or more, such as 0.05 lbs/MSF or more, such as 0.1 lbs/MSF or more, such as 0.2 lbs/MSF or more, such as 0.25 lbs/MSF or more, such as 0.5 lbs/MSF or more, such as 0.75 lbs/MSF or more, such as 1 lb/MSF or more, such as 1.5 lbs/MSF or more, such as 2 lbs/MSF or more, such as 2.5 lbs/MSF or more, such as 3 lbs/MSF or more, such as 4 lbs/MSF or more. The phosphorus containing compound may be present in an amount of 150 lbs/MSF or less, such as 100 lbs/MSF or less, such as 50 lbs/MSF or less, such as 25 lbs/MSF or less, such as 15 lbs/MSF or less, such as 10 lbs/MSF or less, such as 5 lbs/MSF or less, such as 4 lbs/MSF or less, such as 3 lbs/MSF or less, such as 2.5 lbs/MSF or less, such as 2 lbs/MSF or less, such as 1.5 lbs/MSF or less, such as 1 lbs/MSF or less.

If utilized, the polyol compound may be present in the gypsum slurry in an amount of 0.001 wt. % or more, such as 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.5 wt. % or more based on the weight of the calcined gypsum. The polyol compound may be present in an amount of 10 wt. % or less, such as 7 wt. % or less, such as 5 wt. % or less, such as 4 wt. % or less, such as 3 wt. % or less, such as 2.5 wt. % or less, such as 2 wt. % or less, such as 1.8 wt. % or less, such as 1.5 wt. % or less, such as 1 wt. % or less, such as 0.8 wt. % or less, such as 0.6 wt. % or less, such as 0.5 wt. % or less, such as 0.4 wt. % or less, such as 0.35 wt. % or less, such as 0.2 wt. % or less based on the weight of the calcined gypsum composition. In one embodiment, the aforementioned weight percentages may be based on the weight of the calcined gypsum present in the calcined gypsum composition.

If utilized, the polyol compound may be present in an amount of 0.001 lbs/MSF or more, such as 0.01 lbs/MSF or more, such as 0.05 lbs/MSF or more, such as 0.1 lbs/MSF or more, such as 0.2 lbs/MSF or more, such as 0.25 lbs/MSF or more, such as 0.5 lbs/MSF or more, such as 0.75 lbs/MSF or more, such as 1 lb/MSF or more, such as 1.5 lbs/MSF or more, such as 2 lbs/MSF or more, such as 2.5 lbs/MSF or more, such as 3 lbs/MSF or more, such as 4 lbs/MSF or more. The polyol compound may be present in an amount of 150 lbs/MSF or less, such as 100 lbs/MSF or less, such as 50 lbs/MSF or less, such as 25 lbs/MSF or less, such as 15 lbs/MSF or less, such as 10 lbs/MSF or less, such as 5 lbs/MSF or less, such as 4 lbs/MSF or less, such as 3 lbs/MSF or less, such as 2.5 lbs/MSF or less, such as 2 lbs/MSF or less, such as 1.5 lbs/MSF or less, such as 1 lbs/MSF or less.

As indicated above, the gypsum slurry may also include water. Water may be employed for fluidity and also for rehydration of the gypsum to allow for setting. The amount of water utilized is not necessarily limited by the present invention.

In this regard, the weight ratio of the water to the stucco may be 0.1 or more, such as 0.2 or more, such as 0.3 or more, such as 0.4 or more, such as 0.5 or more. The water to stucco weight ratio may be 4 or less, such as 3.5 or less, such as 3 or less, such as 2.5 or less, such as 2 or less, such as 1.7 or less, such as 1.5 or less, such as 1.4 or less, such as 1.3 or less, such as 1.2 or less, such as 1.1 or less, such as 1 or less, such as 0.9 or less, such as 0.85 or less, such as 0.8 or less, such as 0.75 or less, such as 0.7 or less, such as 0.6 or less, such as 0.5 or less, such as 0.4 or less, such as 0.35 or less, such as 0.3 or less, such as 0.25 or less, such as 0.2 or less.

In addition to the calcined gypsum composition and water, the gypsum slurry may also include any other conventional additives as known in the art. Thus, the method may also include providing any of the additives to form the gypsum slurry. In this regard, such additives are not necessarily be limited by the present invention. For instance, the additives may include dispersants, foam or foaming agents including aqueous foam (e.g. sulfates), set accelerators (e.g., BMA, land plaster, sulfate salts, etc.), set retarders, binders, biocides (such as bactericides and/or fungicides), adhesives, pH adjusters, thickeners (e.g., silica fume, Portland cement, fly ash, clay, celluloses, high molecular weight polymers, etc.), leveling agents, non-leveling agents, starches (such as pregelatinized starch, non-pregelatinized starch, and/or an acid modified starch), colorants, fire retardants or additives (e.g., silica, silicates, expandable materials such as vermiculite, perlite, etc.), water repellants, fillers (e.g., glass fibers), waxes, secondary phosphates (e.g., condensed phosphates or orthophosphates including trimetaphosphates, polyphosphates, and/or cyclophosphates, etc.), polymers (natural polymers and/or synthetic polymers), mixtures thereof, etc. In general, it should be understood that the types and amounts of such additives are not necessarily limited by the present invention.

In general, each additive may be present in the gypsum slurry in an amount of 0.0001 wt. % or more, such as 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.5 wt. % or more, such as 1 wt. % or more, such as 2 wt. % or more based on the weight of the stucco. The additive may be present in an amount of 20 wt. % or less, such as 15 wt. % or less, 10 wt. % or less, such as 7 wt. % or less, such as 5 wt. % or less, such as 4 wt. % or less, such as 3 wt. % or less, such as 2.5 wt. % or less, such as 2 wt. % or less, such as 1.8 wt. % or less, such as 1.5 wt. % or less, such as 1 wt. % or less, such as 0.8 wt. % or less, such as 0.6 wt. % or less, such as 0.5 wt. % or less, such as 0.4 wt. % or less, such as 0.35 wt. % or less, such as 0.2 wt. % or less based on the weight of the stucco. In one embodiment, the aforementioned weight percentage may be based on the weight of the gypsum slurry. In another embodiment, the aforementioned weight percentage may be based on the solids content of the gypsum slurry.

As indicated above, the additives may include at least one dispersant. The dispersant is not necessarily limited and may include any that can be utilized within the gypsum slurry and the phosphorus containing compound disclosed herein. The dispersant may include carboxylates (e.g., carboxylate ether, polycarboxylate ether, polycarboxylate ester), sulfates, sulfonates (e.g., naphthalene sulfonate, a lignosulfonate), mixtures thereof, etc. For instance, in one embodiment, the dispersant may include a sulfate.

As indicated above, the additives may include at least one accelerator. The accelerator is not necessarily limited and may include any that can be utilized within the gypsum slurry and the phosphorus containing compound disclosed herein. The accelerator may include ground or unground gypsum such as from a ball mill accelerator, land plaster, sulfate salts, etc., as well as a mixture thereof. In one embodiment, the accelerator may include at least a ball mill accelerator (BMA).

As indicated above, the additives may include at least one foaming agent. The foaming agent is not necessarily limited and may include any that can be utilized within the gypsum slurry and the phosphorus containing compound disclosed herein. In this regard, such foaming agent may be present in the gypsum slurry as well as the resulting gypsum core and gypsum board.

The foaming agent may include an alkyl sulfate, an alkyl ether sulfate, or a mixture thereof. In one embodiment, the foaming agent includes an alkyl sulfate. In another embodiment, the foaming agent includes an alkyl ether sulfate. In a further embodiment, the foaming agent includes an alkyl sulfate without an alkyl ether sulfate. In an even further embodiment, the foaming agent includes a mixture of an alkyl sulfate and an alkyl ether sulfate.

The alkyl sulfate may have a general formula as follows:

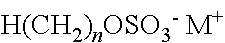

wherein n is from 6 to 16 and M is a monovalent cation. In this regard, the alkyl sulfate includes alkyl chains. The alkyl may be linear, branched, or include a combination thereof. The average chain length of the alkyls may be 6 carbons or more, such as 7 carbons or more, such as 8 carbons or more, such as 9 carbons or more, such as 10 carbons or more, such as 11 carbons or more. The average chain length of the alkyls may be 15 carbons or less, such as 14 carbons or less, such as 13 carbons or less, such as 12 carbons or less, such as 11 carbons or less, such as 10 carbons or less, such as 9 carbons or less. In general, such average chain length is determined based on the length of the alkyl chains, not considering the length of any component of any alkyl ether sulfate that may be present. In addition, such average chain length is a weighted average chain length based on the amount of each specific alkyl present.

The monovalent cation may be sodium or ammonium. In one embodiment, the monovalent cation may be ammonium. In another embodiment, the monovalent cation may be sodium.

The alkyl ether sulfate may have a general formula as follows:

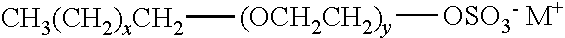

wherein x is from 4 to 13, y is from 0.05 to 5, and M is a monovalent cation.

The alkyl portion of the alkyl ether sulfate may be 6 carbons or more, such as 7 carbons or more, such as 8 carbons or more, such as 9 carbons or more, such as 10 carbons or more, such as 11 carbons or more. Accordingly, x may be 4 or more, such as 5 or more, such as 6 or more, such as 7 or more, such as 8 or more, such as 9 or more, such as 10 or more. The alkyl portion of the alkyl ether sulfate may be 15 carbons or less, such as 14 carbons or less, such as 13 carbons or less, such as 12 carbons or less, such as 11 carbons or less, such as 10 carbons or less, such as 9 carbons or less. Accordingly, x may be 13 or less, such as 11 or less, such as 10 or less, such as 9 or less, such as 8 or less.

The ethoxylated content (y) of the alkyl ether sulfate may be 0.05 or more, such as 0.1 or more, such as 0.2 or more, such as 0.3 or more, such as 0.5 or more, such as 1 or more, such as 1.2 or more, such as 1.5 or more, such as 1.8 or more, such as 2 or more, such as 2.2 or more, such as 2.5 or more, such as 3 or more. The ethoxylated content of the alkyl ether sulfate may be 5 or less, such as 4.8 or less, such as 4.5 or less, such as 4.3 or less, such as 4 or less, such as 3.7 or less, such as 3.5 or less, such as 3.2 or less, such as 3 or less, such as 2.8 or less, such as 2.5 or less, such as 2.3 or less, such as 2 or less, such as 1.7 or less, such as 1.5 or less, such as 1.3 or less, such as 1 or less, such as 0.9 or less, such as 0.7 or less.

The monovalent cation may be sodium or ammonium. In one embodiment, the monovalent cation may be ammonium. In another embodiment, the monovalent cation may be sodium.

When a mixture of an alkyl sulfate and an alkyl ether sulfate is present, the alkyl ether sulfate may be present in an amount of from more than 0 wt. % to less than 100 wt. %. For instance, in the mixture, the alkyl ether sulfate may be present in an amount of more than 0 wt. %, such as 0.01 wt. % or more, such as 0.1 wt. % or more, such as 0.2 wt. % or more, such as 0.3 wt. % or more, such as 0.5 wt. % or more, such as 1 wt. % or more, such as 2 wt. % or more, such as 5 wt. % or more, such as 10 wt. % or more, such as 15 wt. % or more, such as 20 wt. % or more, such as 30 wt. % or more, such as 40 wt. % or more, such as 50 wt. % or more, such as 60 wt. % or more, such as 70 wt. % or more, such as 80 wt. % or more, such as 90 wt. % or more. In the mixture, the alkyl ether sulfate may be present in an amount of less than 100 wt. %, such as 95 wt. % or less, such as 90 wt. % or less, such as 80 wt. % or less, such as 70 wt. % or less, such as 60 wt. % or less, such as 50 wt. % or less, such as 40 wt. % or less, such as 30 wt. % or less, such as 20 wt. % or less, such as 10 wt. % or less, such as 9 wt. % or less, such as 8 wt. % or less, such as 7 wt. % or less, such as 6 wt. % or less, such as 5 wt. % or less, such as 4 wt. % or less, such as 3 wt. % or less, such as 2 wt. % or less. Such weight percentage may be based on the combined weight of the alkyl sulfate and the alkyl ether sulfate.

As indicated, the foaming agent may include a combination of an alkyl sulfate and an alkyl ether sulfate. In this regard, the weight ratio of the alkyl sulfate to the alkyl ether sulfate may be 0.001 or more, such as 0.005 or more, such as 0.01 or more, such as 0.05 or more, such as 0.1 or more, such as 0.2 or more, such as 0.3 or more, such as 0.5 or more, such as 1 or more, such as 2 or more, such as 4 or more, such as 5 or more, such as 10 or more, such as 15 or more, such as 20 or more, such as 25 or more, such as 30 or more, such as 40 or more, such as 50 or more, such as 60 or more, such as 70 or more, such as 80 or more, such as 90 or more, such as 95 or more. The weight ratio may be less than 100, such as 99 or less, such as 98 or less, such as 95 or less, such as 90 or less, such as 85 or less, such as 80 or less, such as 75 or less, such as 70 or less, such as 60 or less, such as 50 or less, such as 40 or less, such as 30 or less, such as 20 or less, such as 15 or less, such as 10 or less, such as 8 or less, such as 5 or less, such as 4 or less, such as 3 or less, such as 2 or less, such as 1 or less.

In another aspect, the alkyl ether sulfate may be present in the foaming agent in an amount of 100 wt. % or less, such as 90 wt. % or less, such as 80 wt. % or less, such as 70 wt. % or less, such as 60 wt. % or less, such as 50 wt. % or less, such as 40 wt. % or less, such as 30 wt. % or less, such as 20 wt. % or less, such as 10 wt. % or less, such as 5 wt. % or less. The alkyl ether sulfate may be present in the foaming agent in an amount of 0.01 wt. % or more, such as 5 wt. % or more, such as 10 wt. % or more, such as 20 wt. % or more, such as 30 wt. % or more, such as 40 wt. % or more, such as 50 wt. % or more, such as 60 wt. % or more, such as 70 wt. % or more, such as 80 wt. % or more, such as 90 wt. % or more.

Additionally, in one aspect, the alkyl sulfate may be present in the foaming agent in an amount of 100 wt. % or less, such as 90 wt. % or less, such as 80 wt. % or less, such as 70 wt. % or less, such as 60 wt. % or less, such as 50 wt. % or less, such as 40 wt. % or less, such as 30 wt. % or less, such as 20 wt. % or less, such as 10 wt. % or less, such as 5 wt. % or less. The alkyl sulfate may be present in the foaming agent in an amount of 0.01 wt. % or more, such as 5 wt. % or more, such as 10 wt. % or more, such as 20 wt. % or more, such as 30 wt. % or more, such as 40 wt. % or more, such as 50 wt. % or more, such as 60 wt. % or more, such as 70 wt. % or more, such as 80 wt. % or more, such as 90 wt. % or more.

By utilizing a soap, foaming agent, and/or foam as disclosed herein, the gypsum slurry may include bubbles or voids having a particular size. Such size may then contribute to the void structure in the gypsum board and the resulting properties.

In one aspect, the foam may be provided in an amount of 1 lb/MSF or more, such as 5 lbs/MSF or more, such as 10 lbs/MSF or more, such as 15 lbs/MSF or more, such as 20 lbs/MSF or more, such as 25 lbs/MSF or more, such as 30 lbs/MSF or more, such as 50 lbs/MSF or more, such as 75 lbs/MSF or more, such as 100 lbs/MSF or more, such as 125 lbs/MSF or more, such as 150 lbs/MSF or more, such as 175 lbs/MSF or more, such as 200 lbs/MSF or more, such as 225 lbs/MSF or more, such as 250 lbs/MSF or more, such as 275 lbs/MSF or more, such as 300 lbs/MSF or more, such as 325 lbs/MSF or more. The foam may be provided in an amount of 350 lbs/MSF or less, such as 325 lbs/MSF or less, such as 300 lbs/MSF or less, such as 275 lbs/MSF or less, such as 250 lbs/MSF or less, such as 225 lbs/MSF or less, such as 200 lbs/MSF or less, such as 175 lbs/MSF or less, such as 150 lbs/MSF or less, such as 125 lbs/MSF or less, such as 100 lbs/MSF or less, such as 80 lbs/MSF or less, such as 60 lbs/MSF or less, such as 50 lbs/MSF or less.

The foam may comprise water and a foaming agent. In one aspect, the foaming agent may be provided in an amount of 0.05 lbs/MSF or more, such as 0.25 lbs/MSF or more, such as 0.5 lbs/MSF or more, such as 0.75 lbs/MSF or more, such as 1 lb/MSF or more, such as 2 lbs/MSF or more, such as 3 lbs/MSF or more, such as 4 lbs/MSF or more. The foaming agent may be provided in an amount of 5 lbs/MSF or less, such as 4 lbs/MSF or less, such as 3 lbs/MSF or less, such as 2 lbs/MSF or less, such as 1 lb/MSF or less, such as 0.5 lbs/MSF or less, such as 0.25 lbs/MSF or less. Further, in one aspect, the water utilized in the foam may be provided in an amount of 70 lbs/MSF or more, such as 75 lbs/MSF or more, such as 100 lbs/MSF or more, such as 125 lbs/MSF or more, such as 150 lbs/MSF or more, such as 175 lbs/MSF or more, such as 200 lbs/MSF or more, such as 225 lbs/MSF or more, such as 250 lbs/MSF or more, such as 275 lbs/MSF or more, such as 300 lbs/MSF or more, such as 325 lbs/MSF or more. The water utilized in the foam may be provided in an amount of 350 lbs/MSF or less, such as 325 lbs/MSF or less, such as 300 lbs/MSF or less, such as 275 lbs/MSF or less, such as 250 lbs/MSF or less, such as 225 lbs/MSF or less, such as 200 lbs/MSF or less, such as 175 lbs/MSF or less, such as 150 lbs/MSF or less, such as 125 lbs/MSF or less, such as 100 lbs/MSF or less.

In one aspect, the foaming agent may be provided in an amount of 0.5 lbs/ft³ or more, such as 1 lb/ft³ or more, such as 1.5 lbs/ft³ or more, such as 2 lbs/ft³ or more, such as 2.5 lbs/ft³ or more, such as 3 lbs/ft³ or more, such as 3.5 lbs/ft³ or more, such as 4 lbs/ft³ or more, such as 4.5 lbs/ft³ or more, such as 5 lbs/ft³ or more. The foaming agent may be provided in an amount of 25 lbs/ft³ or less, such as 20 lbs/ft³ or less, such as 15 lbs/ft³ or less, such as 13 lbs/ft³ or less, such as 11 lbs/ft³ or less, such as 10 lbs/ft³ or less, such as 9 lbs/ft³ or less, such as 8 lbs/ft³ or less, such as 7 lbs/ft³ or less, such as 6 lbs/ft³ or less.

As indicated above, the additives may include a starch. The starch may be one generally utilized in the art. Such starch may be combined with the stucco and water. In this regard, such starch may be present in the gypsum slurry as well as the resulting gypsum core and gypsum board.

The starch may be a corn starch, a wheat starch, a milo starch, a potato starch, a rice starch, an oat starch, a barley starch, a cassava starch, a tapioca starch, a pea starch, a rye starch, an amaranth starch, or other commercially available starch. For example. In one embodiment, the starch may be a corn starch. In another embodiment, the starch may be a wheat starch. In an even further embodiment, the starch may be a milo starch.

Furthermore, the starch may be an unmodified starch or a modified starch. In one embodiment, the starch may be a modified starch. In another embodiment, the starch may be an unmodified starch. In an even further embodiment, the starch may be a mixture of a modified starch and an unmodified starch.

As indicated above, in one embodiment, the starch may be an unmodified starch. For instance, the starch may be a pearl starch (e.g., an unmodified corn starch). In addition, in one embodiment, the starch may also be a non-migrating starch. Also, with respect to gelatinization, the starch may be a non-pregelatinized starch.

As also indicated above, in another embodiment, the starch may be a modified starch. Such modification may be any as typically known in the art and is not necessarily limited. For instance, the modification may be via a physical, enzymatic, or chemical treatment. In one embodiment, the modification may be via a physical treatment. In another embodiment, the modification may be via an enzymatic treatment. In a further embodiment, the modification may be via a chemical treatment. The starch may be treated using many types of reagents. For example, the modification can be conducted using various chemicals, such as inorganic acids (e.g., hydrochloric acid, phosphorous acid or salts thereof, etc.), peroxides (e.g., sodium peroxide, potassium peroxide, hydrogen peroxide, etc.), anhydrides (e.g., acetic anhydride), etc. to break down the starch molecule.

In this regard, in one embodiment, the starch may be a pregelatinized starch, an acid-modified (or hydrolyzed) starch, an extruded starch, an oxidized starch, an oxyhydrolyzed starch, an ethoxylated starch, an ethylated starch, an acetylated starch, a mixture thereof, etc. For example, in one embodiment, the starch may be a pregelatinized starch. In another embodiment, the starch may be an acid-modified (or hydrolyzed) starch. In a further embodiment, the starch may be an extruded starch. In another embodiment, the starch may be an oxidized starch. In a further embodiment, the starch may be an oxyhydrolyzed starch. In another further embodiment, the starch may be an ethoxylated starch. In another embodiment, the starch may be an ethylated starch. In a further embodiment, the starch may be an acetylated starch.

In one embodiment, the starch may be a pregelatinized starch. In this regard, the starch may have been exposed to water and heat for breaking down a certain degree of intermolecular bonds within the starch. As an example and without intending to be limited by theory, during heating, water is absorbed into the amorphous regions of the starch thereby allowing it to swell. Then amylose chains may begin to dissolve resulting in a decrease in the crystallinity and an increase in the amorphous form of the starch.

In another embodiment, the starch may be an acid-modified starch. Such acid modification can be conducted using various chemicals, such as inorganic acids (e.g., hydrochloric acid, phosphorous acid or salts thereof, etc.) to break down the starch molecule. Furthermore, by utilizing acid-modification, the starch may result in a low thinned starch, a medium thinned starch, or a high thinned starch. For example, a higher degree of modification can result in a lower viscosity starch while a lower degree of modification can result in a higher viscosity starch. The degree of modification and resulting viscosity may also affect the degree of migration of the starch. For instance, when presented within the core of the gypsum board, a higher degree of modification and lower viscosity may provide a high migrating starch while a lower degree of modification and higher viscosity may provide a low migrating starch.

The starch may also have a particular gelling temperature. Without intending to be limited, this temperature is the point at which the intermolecular bonds of the starch are broken down in the presence of water and heat allowing the hydrogen bonding sites to engage more water. In this regard, the gelling temperature may be 60° C. or more, such as 80° C. or more, such as 100° C. or more, such as 120° C. or more, such as 140° C. or more, such as 160° C. or more, such as 180° ° C. or more. The gelling temperature may be 300° C. or less, such as 260° C. or less, such as 220° C. or less, such as 200° C. or less, such as 180° C. or less, such as 160° C. or less, such as 140° C. or less, such as 120° C. or less, such as 100° C. or less, such as 80° C. or less. In one embodiment, the aforementioned may refer to a peak gelling temperature.

As indicated above, the starch may have a particular gelling temperature. Without intending to be limited by theory, acid modification may provide a starch having a relatively higher gelling temperature. Meanwhile, without intending to be limited by theory, modifications of the hydroxyl group, such as by replacement via ethoxylation, ethylation, or acetylation may provide a relatively lower gelling temperature or a reduction in gelling temperature. In this regard, in some embodiments, the starch may be acid-modified and chemically modified wherein the hydroxyl groups are substituted.

In one embodiment, the starch may be an extruded starch. For example, the extrusion may provide a thermomechanical process that can break the intermolecular bonds of the starch. Such extrusion may result in the gelatinization of starch due to an increase in the water absorption.

In another embodiment, the starch may be an oxidized starch. For example, the starch may be oxidized using various means known in the art. This may include, but is not limited to, chemical treatments utilizing oxidizing agents such as chlorites, chlorates, perchlorates, hypochlorites (e.g., sodium hypochlorite, etc.), peroxides (e.g., sodium peroxide, potassium peroxide, hydrogen peroxide, etc.), etc. In general, during oxidation, the molecules are broken down yielding a starch with a decreased molecular weight and a reduction in viscosity.

Also, it should be understood that the starch may include a combination of starches, such as any of those mentioned above. For instance, it should be understood that the starch may include more than one different starch. In addition, any combination of modifications may also be utilized to form the starch utilized according to the present invention.

In one aspect, the starch may be provided in an amount of 0.001 lbs/MSF or more, such as 0.01 lbs/MSF or more, such as 0.05 lbs/MSF or more, such as 0.1 lbs/MSF or more, such as 0.2 lbs/MSF or more, such as 0.25 lbs/MSF or more, such as 0.5 lbs/MSF or more, such as 0.75 lbs/MSF or more, such as 1 lb/MSF or more, such as 1.5 lbs/MSF or more, such as 2 lbs/MSF or more, such as 2.5 lbs/MSF or more, such as 3 lbs/MSF or more, such as 4 lbs/MSF or more, such as 5 lbs/MSF or more, such as 8 lbs/MSF or more, such as 10 lbs/MSF or more, such as 15 lbs/MSF or more, such as 20 lbs/MSF or more. The starch may be present in an amount of 50 lbs/MSF or less, such as 30 lbs/MSF or less, such as 25 lbs/MSF or less, such as 20 lbs/MSF or less, such as 15 lbs/MSF or less, such as 10 lbs/MSF or less, such as 5 lbs/MSF or less, such as 4 lbs/MSF or less, such as 3 lbs/MSF or less, such as 2.5 lbs/MSF or less, such as 2 lbs/MSF or less, such as 1.5 lbs/MSF or less, such as 1 lbs/MSF or less.

The manner in which the components are combined to form the gypsum slurry is not necessarily limited. For instance, the gypsum slurry can be made using any method or device generally known in the art. In particular, the components of the slurry can be mixed or combined using any method or device generally known in the art. For instance, the components of the gypsum slurry may be combined in any type of device, such as a mixer and in particular a pin mixer. In this regard, the method may include a step of combining any of the other aforementioned components mentioned above with respect to the gypsum slurry.

Once the gypsum slurry is prepared, the method may comprise a step of depositing the gypsum slurry onto a first facing material. The first facing material may be conveyed on a conveyor system (i.e., a continuous system for continuous manufacture of gypsum board). Next, a second facing material is provided on top of the gypsum slurry such that the gypsum slurry is sandwiched between the facing materials in order to form the gypsum board.

The facing material may be any facing material as generally employed in the art. For instance, the facing material may be a paper facing material, a fibrous (e.g., glass fiber) mat facing material, or a polymeric facing material. In general, the first facing material and the second facing material may be the same type of material. Alternatively, the first facing material may be one type of material while the second facing material may be a different type of material.

In one embodiment, the facing material may include a paper facing material. For instance, both the first and second facing materials may be a paper facing material. Alternatively, in another embodiment, the facing material may be a glass mat facing material. For instance, both the first and second facing materials may be a glass mat facing material. In a further embodiment, the facing material may be a polymeric facing material. For instance, both the first and second facing materials may be a polymeric facing material.

After deposition, the calcium sulfate hemihydrate reacts with the water to convert the calcium sulfate hemihydrate into a matrix of calcium sulfate dihydrate. Such reaction may allow for the gypsum to set and become firm thereby allowing for the boards to be cut at the desired length. In this regard, the method may comprise a step of reacting calcium sulfate hemihydrate with water to form calcium sulfate dihydrate or allowing the calcium sulfate hemihydrate to convert to calcium sulfate dihydrate. In this regard, the method may allow for the slurry to set to form a gypsum board. In addition, during this process, the method may allow for dewatering of the gypsum slurry, in particular dewatering any free water instead of combined water of the gypsum slurry. Such dewatering may occur prior to the removal of any free moisture or water in a heating device after a cutting step. Thereafter, the method may also comprise a step of cutting a continuous gypsum sheet into a gypsum board. Then, after the cutting step, the method may comprise a step of supplying the gypsum board to a heating or drying device. For instance, such a heating or drying device may be a kiln and may allow for removal of any free water. The temperature and time required for drying in such heating device are not necessarily limited by the present invention.

In addition, the present invention is also directed to a gypsum board. The gypsum board includes a gypsum core sandwiched between two facing materials. The gypsum board may comprise calcium sulfate dihydrate and a phosphorus containing compound as defined herein or a salt thereof. If utilized, the gypsum board may also comprise a polyol compound as defined herein. The manner in which the gypsum board is made is as provided herein utilizing the aforementioned application, calcination, preparation, and deposition steps.

In one embodiment, the gypsum core may include a first gypsum core layer and a second gypsum core layer. The first gypsum core layer may be between the first facing material (i.e., front of the gypsum board) and the second gypsum core layer. In addition, the first gypsum core layer may have a density greater than the second gypsum core layer. Accordingly, the first gypsum core layer may be formed using a gypsum slurry without the use of foam and/or a foaming agent or with a reduced amount of foam and/or a foaming agent, which may be utilized in forming the second gypsum core layer. In this regard, in one embodiment, the first gypsum core layer may have the same composition as the second gypsum core layer except that the second gypsum core layer may be formed using foam and/or a foaming agent or a greater amount of foam and/or a foaming agent.

In one embodiment, the gypsum core may also include a third gypsum core layer. The third gypsum core layer may be provided between the second gypsum core layer and a second facing material (i.e., back of the gypsum board). Like the first gypsum core layer, the third gypsum core layer may also be a dense gypsum core layer. In particular, the third gypsum core layer may have a density greater than the second gypsum core layer. Accordingly, the third gypsum core layer may be formed using a gypsum slurry without the use of foam and/or a foaming agent or with a reduced amount of foam and/or a foaming agent, which may be utilized in forming the second gypsum core layer. In this regard, in one embodiment, the third gypsum core layer may have the same composition as the second gypsum core layer except that the second gypsum core layer may be formed using foam and/or a foaming agent or a greater amount of foam and/or a foaming agent.

When the gypsum core includes multiple gypsum core layers, the gypsum slurry may be deposited in multiple steps for forming the gypsum core. For instance, each gypsum core layer may require a separate deposition of gypsum slurry. In this regard, with a first gypsum core layer and a second gypsum core layer, a first gypsum slurry may be deposited followed by a second gypsum slurry. The first gypsum slurry and the second gypsum slurry may have the same composition except that the second gypsum slurry may include foam and/or a foaming agent or more foam and/or a foaming agent than the first gypsum slurry. In this regard, in one embodiment, the first gypsum slurry may not include foam and/or a foaming agent. Accordingly, the first gypsum slurry may result in a dense gypsum core layer, in particular a non-foamed gypsum core layer. Such gypsum core layer may have a density greater than the gypsum core layer formed from the second gypsum slurry, or foamed gypsum core layer.

Similarly, when the gypsum core includes three gypsum core layers, the gypsum slurry may be deposited in three steps for forming the gypsum core. For example, a first and second gypsum slurry may be deposited as indicated above and a third gypsum slurry may be deposited onto the second gypsum slurry. The third gypsum slurry and the second gypsum slurry may have the same composition except that the second gypsum slurry may include foam and/or a foaming agent or more foam and/or a foaming agent than the third gypsum slurry. In this regard, in one embodiment, the third gypsum slurry may not include foam and/or a foaming agent. Accordingly, the third gypsum slurry may result in a dense gypsum core layer, in particular a non-foamed gypsum core layer. Such gypsum core layer may have a density greater than the gypsum core layer formed from the second gypsum slurry, or foamed gypsum core layer.

The first gypsum core layer may have a thickness that is 0.5% or more, such as 1% or more, such as 2% or more, such as 3% or more, such as 4% or more, such as 5% or more, such as 10% or more, such as 15% or more than the thickness of the second (or foamed) gypsum core layer. The thickness may be 80% or less, such as 60% or less, such as 50% or less, such as 40% or less, such as 30% or less, such as 25% or less, such as 20% or less, such as 15% or less, such as 10% or less, such as 8% or less, such as 5% or less the thickness of the second (or foamed) gypsum core layer. In one embodiment, such relationship may also be between the third gypsum core layer and the second gypsum core layer.

The density of the second (or foamed) gypsum core layer may be 0.5% or more, such as 1% or more, such as 2% or more, such as 3% or more, such as 4% or more, such as 5% or more, such as 10% or more, such as 15% or more the density of the first (or non-foamed) gypsum core layer. The density of the second (or foamed) gypsum core layer may be 80% or less, such as 60% or less, such as 50% or less, such as 40% or less, such as 30% or less, such as 25% or less, such as 20% or less, such as 15% or less, such as 10% or less, such as 8% or less, such as 5% or less the density of the first (or non-foamed) gypsum core layer. In one embodiment, such relationship may also be between the third gypsum core layer and the second gypsum core layer. In addition, in one embodiment, all of the gypsum core layers may have a different density.

Generally, the first gypsum core layer, the second gypsum core layer, and/or the third gypsum core layer may contain any of the additives as disclosed herein, such as the phosphorus containing compound as defined herein. They may also respectively contain the polyol compound as defined herein if utilized. Further, the first gypsum core layer, the second gypsum core layer, and/or the third gypsum core layer may contain an additive in an amount as previously indicated herein.

Regardless of the above, the phosphorus containing compound may be present in any combination of gypsum core layers. However, in one embodiment, it should be understood that one or two of the aforementioned gypsum core layers may not include the phosphorus containing compound. In one aspect, one or more gypsum core layers may comprise the same phosphorus containing compound. Further, in one aspect, the one or more gypsum core layers may comprise different phosphorus containing compounds. The different phosphorus containing compounds of the one or more gypsum core layers may be chosen such that it is advantageous to have a particular phosphorus containing compound in one gypsum core layer and a different phosphorus containing compound in another, different gypsum core layer.

Further, regardless of the above, if utilized, the polyol compound may be present in any combination of gypsum core layers. However, in one embodiment, it should be understood that one or two of the aforementioned gypsum core layers may not include the polyol compound. In one aspect, one or more gypsum core layers may comprise the same polyol compound. Further, in one aspect, the one or more gypsum core layers may comprise different polyol compounds. The different polyol compounds of the one or more gypsum core layers may be chosen such that it is advantageous to have a particular polyol compound in one gypsum core layer and a different polyol compound in another, different gypsum core layer.

Furthermore, if utilized, the polyol compound may be present in the same gypsum core layers as the phosphorus containing compound in one embodiment.

The gypsum board disclosed herein may have many applications. For instance, the gypsum board may be used as a standalone board in construction for the preparation of walls, ceilings, floors, etc. As used in the present disclosure, the term “gypsum board,” generally refers to any board, sheet, or planar structure, either uniform or formed by connected portions or pieces, that is constructed to at least partially establish one or more physical boundaries. Such existing, installed, or otherwise established or installed wall or ceiling structures comprise materials that may include, as non-limiting examples, gypsum, stone, ceramic, cement, wood, composite, or metal materials. The installed gypsum board forms part of a building structure, such as a wall or ceiling.

The specific surface area of the gypsum core is not necessarily limited and may be from about 0.25 m²/g to about 15 m²/g. For instance, the specific surface area may be 0.25 m²/g or more, such as 0.5 m²/g or more, such as 1 m²/g or more, such as 1.5 m²/g or more, such as 2 m²/g or more, such as 2.5 m²/g or more, such as 3 m²/g or more, such as 3.5 m²/g or more, such as 4 m²/g or more, such as 5 m²/g or more, such as 6 m²/g or more, such as 8 m²/g or more, such as 10 m²/g or more. The specific surface area of the gypsum core may be 15 m²/g or less, such as 10 m²/g or less, such as 8 m²/g or less, such as 6 m²/g or less, such as 4 m²/g or less, such as 3.5 m²/g or less, such as 3 m²/g or less, such as 2.5 m²/g or less, such as 2 m²/g or less, such as 1.5 m²/g or less, such as 1 m²/g or less.

The thickness of the gypsum board is not necessarily limited and may be from about 0.25 inches to about 1 inch. For instance, the thickness may be at least ¼ inches, such as at least 5/16 inches, such as at least ⅜ inches, such as at least 4/10 inches, such as at least ½ inches, such as at least ⅝ inches, such as at least ¾ inches, such as at least 1 inch. In this regard, the thickness may be about any one of the aforementioned values. For instance, the thickness may be about ¼ inches. Alternatively, the thickness may be about ⅜ inches. In another embodiment, the thickness may be about ½ inches. In a further embodiment, the thickness may be about ⅝ inches. In another further embodiment, thickness may be about 1 inch. With regard to the thickness, the term “about” may be defined as within 10%, such as within 5%, such as within 4%, such as within 3%, such as within 2%, such as within 1%.

In this regard, the gypsum board may have a density of about 5 pcf or more, such as about 10 pcf or more, such as about 15 pcf or more, such as about 20 pcf or more. The board may have a density of about 60 pcf or less, such as about 50 pcf or less, such as about 40 pcf or less, such as about 35 pcf or less, such as about 33 pcf or less, such as about 30 pcf or less, such as about 28 pcf or less, such as about 25 pcf or less, such as about 23 pcf or less, such as about 20 pcf or less.

In addition, the board weight of the gypsum board is not necessarily limited. For instance, the gypsum board may have a board weight of 500 lbs/MSF or more, such as about 600 lbs/MSF or more, such as about 700 lbs/MSF or more, such as about 800 lbs/MSF or more, such as about 900 lbs/MSF or more, such as about 1000 lbs/MSF or more, such as about 1100 lbs/MSF or more, such as about 1200 lbs/MSF or more, such as about 1300 lbs/MSF or more, such as about 1400 lbs/MSF or more, such as about 1500 lbs/MSF or more, such as about 2000 lbs/MSF or more, such as about 2500 lbs/MSF or more, such as about 3000 lbs/MSF or more. The board weight may be about 5000 lbs/MSF or less, such as about 4500 lbs/MSF or less, such as about 4000 lbs/MSF or less, such as about 3500 lbs/MSF or less, such as about 3000 lbs/MSF or less, such as about 2500 lbs/MSF or less, such as about 2000 lbs/MSF or less, such as about 1800 lbs/MSF or less, such as about 1600 lbs/MSF or less, such as about 1500 lbs/MSF or less, such as about 1400 lbs/MSF or less, such as about 1300 lbs/MSF or less, such as about 1200 lbs/MSF or less. Such board weight may be a dry board weight such as after the board leaves the heating or drying device (e.g., kiln).

In addition to the above, the gypsum board may have a particular void structure. For instance, the percentage of core voids having a diameter of less than 300 microns may be 50% or less, such as 40% or less, such as 35% or less, such as 30% or less, such as 25% or less, such as 20% or less, such as 15% or less, such as 10% or less of the total core voids. In this regard, the percentage of core voids having a diameter of less than 300 microns may be 0.01% or more, such as 0.1% or more, such as 0.2% or more, such as 0.5% or more, such as 1% or more, such as 2% or more, such as 3% or more, such as 5% or more. In one embodiment, such core voids may reference any air voids due to voids generated from the use of a soap/foam.

Similarly, the percentage of core voids having a diameter of less than 150 microns may be 40% or less, such as 35% or less, such as 30% or less, such as 25% or less, such as 20% or less, such as 15% or less, such as 10% or less, such as 5% or less of the total core voids. In this regard, the percentage of core voids having a diameter of less than 150 microns may be 0.01% or more, such as 0.1% or more, such as 0.2% or more, such as 0.5% or more, such as 1% or more, such as 2% or more, such as 3% or more, such as 5% or more, such as 8% or more. In one embodiment, such core voids may reference any air voids due to voids generated from the use of a soap/foam.

Further, the percentage of core voids having a diameter of less than 100 microns may be 60% or less, such as 50% or less, such as 40% or less, such as 35% or less, such as 30% or less, such as 25% or less, such as 20% or less, such as 15% or less, such as 10% or less, such as 5% or less of the total core voids. In this regard, the percentage of core voids having a diameter of less than 100 microns may be 0.01% or more, such as 0.1% or more, such as 0.2% or more, such as 0.5% or more, such as 1% or more, such as 2% or more, such as 3% or more, such as 5% or more, such as 8% or more. In one embodiment, such core voids may reference any air voids due to voids generated from the use of a soap/foam.

In addition, the percentage of core voids having a diameter of less than 50 microns may be 30% or less, such as 25% or less, such as 20% or less, such as 15% or less, such as 10% or less, such as 5% or less of the total core voids. In this regard, the percentage of core voids having a diameter of less than 50 microns may be 0.01% or more, such as 0.1% or more, such as 0.2% or more, such as 0.5% or more, such as 1% or more, such as 2% or more, such as 3% or more, such as 5% or more, such as 8% or more. In one embodiment, such core voids may reference any air voids due to voids generated from the use of a soap/foam.

In addition, the average core void size may be 50 microns or more, such as 75 microns or more, such as 100 microns or more, such as 125 microns or more, such as 150 microns or more, such as 200 microns or more, such as 250 microns or more, such as 275 microns or more, such as 300 microns or more, such as 325 microns or more, such as 350 microns or more, such as 375 microns or more, such as 400 microns or more, such as 500 microns or more, such as 600 microns or more, such as 700 microns or more, such as 800 microns or more, such as 900 microns or more, such as 1,000 microns or more. The average core void size may be 1,500 microns or less, such as 1,300 microns or less, such as 1,100 microns or less, such as 1,000 microns or less, such as 900 microns or less, such as 800 microns or less, such as 700 microns or less, such as 600 microns or less, such as 550 microns or less, such as 500 microns or less, such as 450 microns or less, such as 400 microns or less, such as 375 microns or less, such as 350 microns or less, such as 325 microns or less, such as 300 microns or less, such as 275 microns or less, such as 250 microns or less, such as 225 microns or less, such as 200 microns or less, such as 175 micron or less, such as 150 microns or less, such as 125 microns or less, such as 100 microns or less. In one embodiment, such core voids may reference any air voids due to voids generated from the use of a soap/foam. Furthermore, while the aforementioned references an average core void size, it should be understood that in another embodiment, such size may also refer to a median core void size.

The void sizes may be determined using means in the art. For instance, a scanning electron microscope may be utilized wherein cross-sections are analyzed at a 50× magnification at random locations of a board with one each close to the face of the board, one in the center of the board, and one close to the back of the board. The voids are measured in an area of approximately 4 mm2 and the average and median sizes are based on measuring all voids having a size of 30 microns or greater in diameter. During the review, edge circumferences are drawn on the voids and measured to calculate the void size and area.

In addition to the above, the gypsum board may have certain desired mechanical properties or strength. The gypsum board may have a certain nail pull resistance, which generally is a measure of the force required to pull a gypsum board off a wall by forcing a fastening nail through the board. The values obtained from the nail pull test generally indicate the maximum stress achieved while the fastener head penetrates through the board surface and core. In certain embodiments, the nail pull resistance may be improved due to the use of the phosphorus containing compound as defined herein. In this regard, the gypsum board exhibits a nail pull resistance of at least about 25 lb_{f}, such as at least about 30 pounds, such as at least about 35 lb_{f}, such as at least about 40 lb_{f}, such as at least about 45 lb_{f}, such as at least about 50 lb_{f}, such as at least about 55 lb_{f}, such as at least about 60 lb_{f}, such as at least about 65 lb_{f}, such as at least about 70 lb_{f}, such as at least about 75 lb_{f}, such as at least about 77 lb_{f}, such as at least about 80 lb_{f}, such as at least about 85 lb_{f}, such as at least about 90 lb_{f}, such as at least about 95 lb_{f}, such as at least about 100 lb_{f} as determined according to ASTM C1396. The nail pull resistance may be about 150 lb_{f} or less, such as about 140 lb_{f} or less, such as about 130 lb_{f} or less, such as about 120 lb_{f} or less, such as about 110 lb_{f} or less, such as about 105 lb_{f} or less, such as about 100 lb_{f} or less, such as about 95 lb_{f} or less, such as about 90 lb_{f} or less, such as about 85 lb_{f} or less, such as about 80 lb_{f} or less as determined according to ASTM C1396. Such nail pull resistance may be based upon the thickness of the gypsum board. For instance, when conducting a test, such nail pull resistance values may vary depending on the thickness of the gypsum board. As an example, the nail pull resistance values above may be for a ⅝ inch board. However, it should be understood that instead of a ⅝ inch board, such nail pull resistance values may be for any other thickness gypsum board as mentioned herein.

The gypsum board may have a certain compressive strength. For instance, the compressive strength may be about 150 psi or more, such as about 200 psi or more, such as about 250 psi or more, such as about 300 psi or more, such as about 350 psi or more, such as about 375 psi or more, such as about 400 psi or more, such as about 500 psi or more as tested according to ASTM C473. The compressive strength may be about 3000 psi or less, such as about 2500 psi or less, such as about 2000 psi or less, such as about 1700 psi or less, such as about 1500 psi or less, such as about 1300 psi or less, such as about 1100 psi or less, such as about 1000 psi or less, such as about 900 psi or less, such as about 800 psi or less, such as about 700 psi or less, such as about 600 psi or less, such as about 500 psi or less. Such compressive strength may be based upon the thickness of the gypsum board. For instance, when conducting a test, such compressive strength values may vary depending on the thickness of the gypsum board. As an example, the compressive strength values above may be for a ⅝ inch board. However, it should be understood that instead of a ⅝ inch board, such compressive strength values may be for any other thickness gypsum board as mentioned herein.

In addition, the gypsum board may have a core hardness of at least about 8 lb_{f}, such as at least about 10 pounds, such as at least about 11 lb_{f}, such as at least about 12 lb_{f}, such as at least about 15 lb_{f}, such as at least about 18 lb_{f}, such as at least about 20 lb_{f} as determined according to ASTM C1396. The gypsum board may have a core hardness of 50 lb_{f} or less, such as about 40 lb_{f} or less, such as about 35 lb_{f} or less, such as about 30 lb_{f} or less, such as about 25 lb_{f} or less, such as about 20 lb_{f} or less, such as about 18 lb_{f} or less, such as about 15 lb_{f} or less as determined according to ASTM C1396. In addition, the gypsum board may have an end hardness according to the aforementioned values. Further, the gypsum board may have an edge hardness according to the aforementioned values. Such core hardness may be based upon the thickness of the gypsum board. For instance, when conducting a test, such core hardness values may vary depending on the thickness of the gypsum board. As an example, the core hardness values above may be for a ⅝ inch board. However, it should be understood that instead of a ⅝ inch board, such core hardness values may be for any other thickness gypsum board as mentioned herein.

In addition, it may also be desired to have an effective bond between the facing material and the gypsum core. Typically, a humidified bond analysis is performed for 2 hours in a humidity chamber at 90° F. and 90% humidity. In this test, after exposure, the facing material is removed to determine how much remains on the gypsum board. The percent coverage can be determined using various optical analytical techniques. In this regard, the facing material may cover less than 50%, such as less than 40%, such as less than 30%, such as less than 25%, such as less than 20%, such as less than 15%, such as less than 10%, such as less than 9%, such as less than 8% of the surface area of the gypsum core upon conducting the test. Such percentage may be for a face of the gypsum board. Alternatively, such percentage may be for a back of the gypsum board. Further, such percentages may apply to the face and the back of the gypsum board. In addition, such values may be for an average of at least 3 gypsum boards, such as at least 5 gypsum boards.

### EXAMPLES

### Example 1

Gypsum boards were made wherein certain samples included a sodium monofluorophosphate (SMFP) applied to a gypsum composition at an amount of 0.2 wt. % based on the weight of the gypsum. In addition, certain samples included a combination of an alkyl sulfate foaming agent and an alkyl ether sulfate foaming agent while other samples simply included an alkyl sulfate foaming agent. The alkyl sulfate foaming agent included approximately 30 wt. % actives and the alkyl ether sulfate foaming agent included approximately 60 wt. % The gypsum compositions were calcined wherein the calcined gypsum composition was formed into a slurry and combined with water and the respective foaming agent. Thereafter, the slurry was provided between paper facing materials and allowed to set.

The gypsum boards were analyzed to determine the effect of the application of the sodium monofluorophosphate before calcination as well as the foaming agent on the void structure.

| Sample | <150 μm (%) | MP (μm) |
|---|---|---|
| Control | 24.3 | 210 |
| (90/10 alkyl sulfate foaming | | |
| agent/alkyl ether sulfate | | |
| foaming agent) | | |
| 0.2% SMFP | 28.8 | 250 |
| (90/10 alkyl sulfate foaming | | |
| agent/alkyl ether sulfate | | |
| foaming agent) | | |
| Control | 35.7 | 183 |
| (100% alkyl sulfate | | |
| foaming agent) | | |
| 0.2% SMFP | 39.1 | 205 |
| (100% alkyl sulfate | | |
| foaming agent) | | |

As indicated by the data above, usage of the sodium monofluorophosphate resulted in milder coalescing of the bubbles/voids compared to the respective control. For instance, a greater percentage of smaller voids were obtained when the board was made based on application of the SMFP precalcination.

These and other modifications and variations of the present invention may be practiced by those of ordinary skill in the art without departing from the spirit and scope of the present invention. In addition, it should be understood that aspects of the various embodiments may be interchanged both in whole or in part. Furthermore, those of ordinary skill in the art will appreciate that the foregoing description is by way of example only and is not intended to limit the invention so further described in such appended claims.

1-30. (canceled)

31. A method for making a gypsum board, the method comprising:
applying a phosphorus containing compound to a first gypsum composition to provide a phosphorus modified gypsum composition,
wherein the phosphorus containing compound comprises a phosphite, a phosphate having the formula P(O)ₙ(X)ₘ wherein n is from 0 to 4, m is from 0 to 6, the sum of n and m is from 3 to 6, and X is hydrogen, halogen, sulfur, or selenium, a salt thereof, or a mixture thereof;
calcining the phosphorus modified gypsum composition to provide a calcined gypsum composition;
preparing a gypsum slurry by combining water and the calcined gypsum composition;
depositing the gypsum slurry on a first facing material;
providing a second facing material on the gypsum slurry; and
allowing the calcined gypsum to convert to calcium sulfate dihydrate.

32. The method of claim 31, wherein the phosphorus containing compound comprises a phosphate having the formula P(O)ₙ(X)ₘ wherein n is from 0 to 4, m is from 0 to 6, the sum of n and m is from 3 to 6, and X is hydrogen, halogen, sulfur, or selenium, a salt thereof.

33. The method of claim 32, wherein X includes fluoro.

34. The method of claim 32, wherein n is from 2 to 3.

35. The method of claim 32, wherein m is from 1 to 2.

36. The method of claim 31, wherein the phosphorus containing compound comprises a halophosphate.

37. The method of claim 31, wherein the phosphorus containing compound comprises a salt including an alkali metal, an alkaline earth metal, a transition metal, or a combination thereof.

38. The method of claim 31, wherein the phosphorus containing compound comprises sodium monofluorophosphate.

39. The method of claim 31, wherein the gypsum slurry further comprises a foaming agent comprising an alkyl sulfate, an alkyl ether sulfate, or a mixture thereof.

40. The method of claim 31, wherein the first gypsum composition comprises reclaimed gypsum.

41. The method of claim 31, wherein the first gypsum composition comprises reclaimed gypsum and virgin gypsum.

42. The method of claim 31, wherein the first gypsum composition comprises an organosilicon compound.

43. The method of claim 31, wherein the first gypsum composition comprises a polysiloxane.

44. The method of claim 31, wherein the first gypsum composition comprises a polymethylhydrosiloxane.

45. The method of claim 31, wherein the first gypsum composition comprises reclaimed gypsum and an organosilicon compound.

46. The method of claim 45, wherein the organosilicon compound comprises a polysiloxane.

47. The method of claim 45, wherein the organosilicon compound comprises a polymethylhydrosiloxane.

48. The method of claim 40, further comprising combining the modified gypsum composition with virgin gypsum to provide a second gypsum composition, calcining the second gypsum composition to provide the calcined gypsum composition.

49. The method of claim 45, further comprising combining the modified gypsum composition with virgin gypsum to provide a second gypsum composition, calcining the second gypsum composition to provide the calcined gypsum composition.

50. A gypsum board made from the method of claim 31.

51. A method for making a gypsum board, the method comprising:
applying a phosphorus containing compound to a first gypsum composition to provide a phosphorus modified gypsum composition,
wherein the first gypsum composition comprises reclaimed gypsum and an organosilicon compound,
wherein the phosphorus containing compound comprises a phosphite, a phosphate having the formula P(O)ₙ(X)ₘ wherein n is from 0 to 4, m is from 0 to 6, the sum of n and m is from 3 to 6, and X is hydrogen, halogen, sulfur, or selenium, a salt thereof, or a mixture thereof;
calcining the phosphorus modified gypsum composition to provide a calcined gypsum composition;
preparing a gypsum slurry by combining water and the calcined gypsum composition;
depositing the gypsum slurry on a first facing material;
providing a second facing material on the gypsum slurry; and
allowing the calcined gypsum to convert to calcium sulfate dihydrate.

52. The method of claim 51, wherein the first gypsum composition further comprises virgin gypsum.

53. The method of claim 51, further comprising combining the modified gypsum composition with virgin gypsum to provide a second gypsum composition, calcining the second gypsum composition to provide the calcined gypsum composition.

54. A gypsum board made from the method of claim 51.
